(19) United States
(12) Patent Application Publication
(10) Pub. No.: US 2007/0011021 A1
(43) Pub. Date: Jan. 11, 2007

(54) Method & System for Integrating Real Estate Brokerage, Mortgage, Title, and Insurance Services

(75) Inventors: John A. Worstell, Ogden Dunes, IN (US); Brian Matthew Saving, Palos Heights, IL (US)

Correspondence Address: BARNES & THORNBURG LLP, P.O. BOX 2786, CHICAGO, IL, 60690-2786, US

(73) Assignee: RMIT Mortgage, Inc., Valparaiso, IN (US)

(21) Appl. No.: 11/423,664

(22) Filed: Jun. 12, 2006

Related U.S. Application Data
(60) Provisional application No. 60/689,459, filed on Jun. 10, 2005.

(51) Int. Cl. G06Q 99/00

(52) U.S. Cl. 705/1

(57) ABSTRACT

A business affiliation structure that encourages and facilitates a number of related real estate service providers, under the supervision of a parent company, to cooperate to provide real estate services to consumers in a more efficient and cost-effective manner. The related real estate service providers work cooperatively to form a consulting team that meets the needs of their mutual clients. Also disclosed is a system and method that includes a point of sale interface usable by service providers for creating, maintaining, and sharing transaction-related information. Also disclosed is a distribution arrangement that governs revenue and services among the affiliated companies.

### RELATED APPLICATION

This Application claims priority to U.S. Provisional Patent Application 60/689,459 filed Jun. 10, 2005, which is expressly incorporated herein by reference in its entirety

### BACKGROUND AND SUMMARY

The present disclosure relates to providing a combined offering of real estate services to consumers. The present disclosure also relates to a system and method used by real estate service providers to facilitate providing the integrated services.

Real estates services are generally provided by separate companies and may be divided generally into five categories: (1) mortgage, (2) title, (3) insurance, (4) real estate brokerage, and (5) builders. Consumers as well as business real estate buyers and sellers (generally, “consumers”) may be overwhelmed in dealing with, and providing information to, the various service providers in the course of even a single real estate transaction. Presently, real estate service providers spend time and resources interacting with other real estate service providers which leads to increased costs which are passed on to the consumers.

Briefly, and in accordance with the foregoing, disclosed is a business affiliation structure that encourages and facilitates five related real estate services businesses, under the supervision of a parent company, to work together to provide real estate services to consumers in a more efficient and cost-effective manner. The five related real estate services businesses work cooperatively to form a consulting team that meets the needs of their mutual clients. Also disclosed is a system and method that includes a point of sale interface usable by service providers for creating, maintaining, and sharing transaction-related information. Also disclosed is a distribution arrangement that governs revenue and services among the affiliated companies.

Additional features and embodiments will become apparent to those skilled in the art upon consideration of the following detailed description of drawings.

### BRIEF DESCRIPTION OF THE DRAWINGS

The present disclosure will be described hereafter with reference to the attached drawings which are given as a non-limiting example only, in which:

FIG. 1 is a simplified diagrammatic view of business structure for providing integrated real estate services.

FIG. 2 is a diagrammatic view of role distributions and profit sharing among players in a mortgage transaction;

FIG. 3 is a diagrammatic view of a system for sharing consumer information among real estate services providers;

FIG. 4 is a diagrammatic view of a matrix for document access related to the BISS system;

FIG. 4A is a table describing the accessibility of each entity;

FIG. 5 is a diagrammatic view of a matrix for insurance company access;

FIG. 6 is a diagrammatic view of a matrix for mortgage company access;

FIG. 7 is a diagrammatic view of a matrix for real estate broker access;

FIG. 8 is a diagrammatic view of a matrix for title company access; and

FIGS. 9-12 are a visual narrative of information being added, modified, and accessed in a master file.

### DETAILED DESCRIPTION

The present disclosure comprises one or more of the features or combinations thereof disclosed above or in the Detailed Description below.

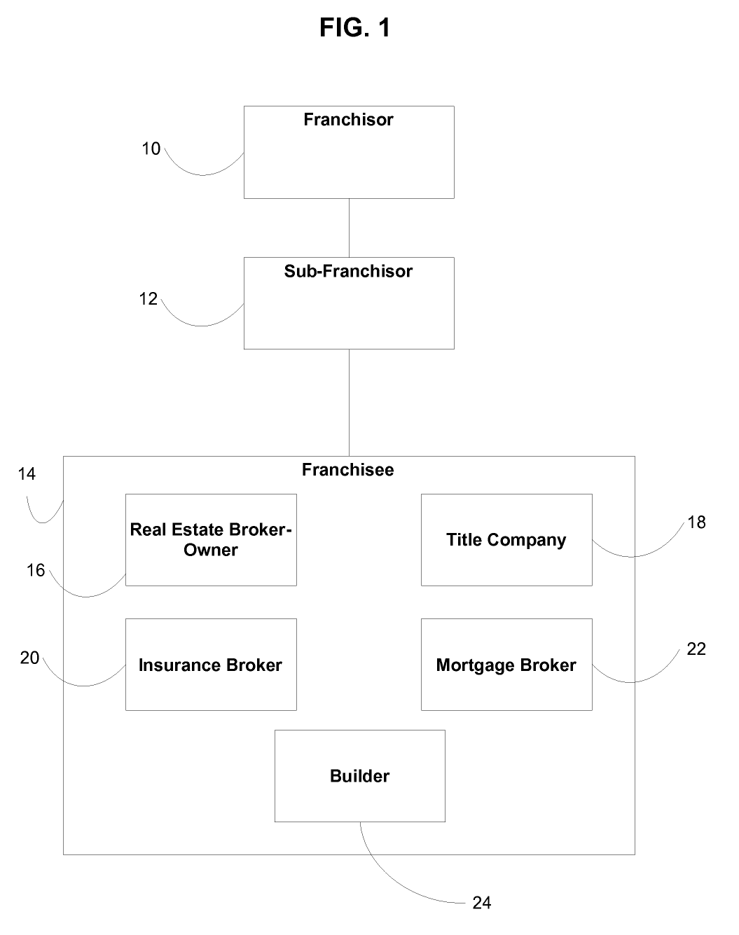

FIG. 1 is a diagrammatic view of a structure of integrated service providers. The term “franchise” as used in this disclosure is generally used to refer to the name of a business that is operated by a franchisee and to whom a franchiser grants the right to market a service and may provide another option to start a business. The franchisee generally pays a fee and/or a percentage of sales to the franchiser for receiving financial help, training, supplies, a protected market and technical assistance from the franchiser.

As shown in a FIG. 1, a franchiser 10 may generally organize and manage the affiliation or structure shown. The franchiser 10 may be responsible for a number of services that flow down through the structure to the service providers including but not limited to national or regional education and training, development, referrals to building supply companies, hosting, and maintenance of software and other technology, selection and approval of insurance underwriters and mortgage wholesalers, and other services.

It is envisioned that one national franchisor 10 may enroll fifty regional sub-franchisors 12, each sub-franchisor generally assigned a state or other population concentration corresponding to a state-like division of the country. The sub-franchisor 12 in turn locates and develops one or more franchisees 14 in developing a franchisee structure for providing integrated real estate services to consumers. A franchisee 14 is generally set up as a holding company that includes one or more of a real estate broker-owner 16, a title company 18, an insurance broker 20, a mortgage broker 22, and a building company or builder 24.

A sub-franchisor will receive a fee from the franchisee 14. This fee may be, for example, 8% of each margin collected for the services provided. In turn, the sub-franchisor may pay a fee to the franchisor 10, for example, 25% of the 8% fee received from the franchisee 14. The sub-franchisor may provide numerous services to the franchisee 14 including assistance in setting up the holding company, business development, training, help with regional laws and regulations related to each service, local technology support and national and local advertising. Some mutually beneficial exchange of value for marketing purposes, such as a marketing fee, may exist as well.

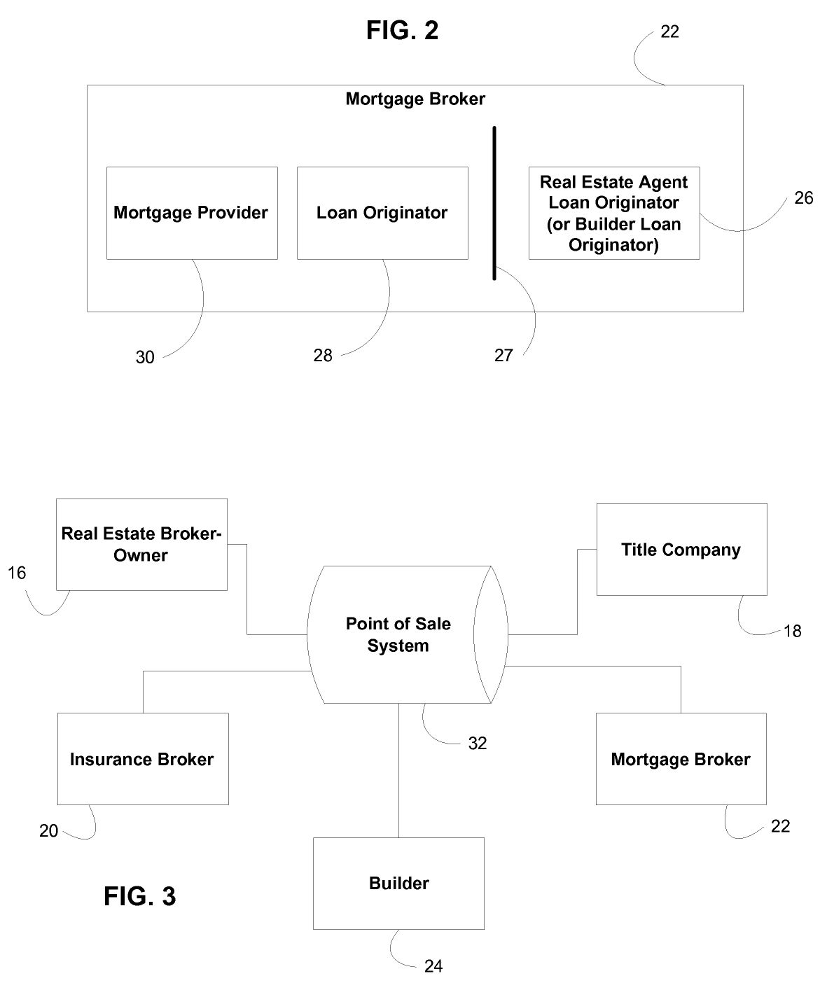

As shown in FIG. 2, specific tasks, information gathering, and commissions related to the mortgage provider's services may be divided in connection with business structure shown in FIG. 1. In particular, a real estate agent loan originator or builder loan originator 26 may be used initially to collect certain information from a consumer. That information may include one or more of specific client information, disclosure information, Form 1003 information, and license information. That information is in turn passed over to another loan originator 28 through a procedural division or wall 27. The mortgage company loan originator is responsible for further advancing and the loan through closing. The use of both a real estate loan originator 26 and second loan originator 28 is to allow real estate sales agents to give informed but broad advice to their clients regarding the mortgage process, while still ensuring that mortgage related tasks are completed by mortgage professionals working within their area of core competency. Under this structure, the tasks performed by the loan originator 26 may be sufficient to allow the real estate agent or builder 26 to receive a portion of the mortgage commission which may be required for compliance with applicable state and/or federal laws and regulations. A commission may be split between the three players 26, 28, 30 such as a 25%, 25%, 50% split respectively. Any commissions received would be subject to the 8% (or other selected percentage) sub-franchisor fee before the revenues are split between these three entities. The loan originator may be an employee of the mortgage company, an independent contractor, or some hybrid (salary as an employee, commission as an independent contractor).

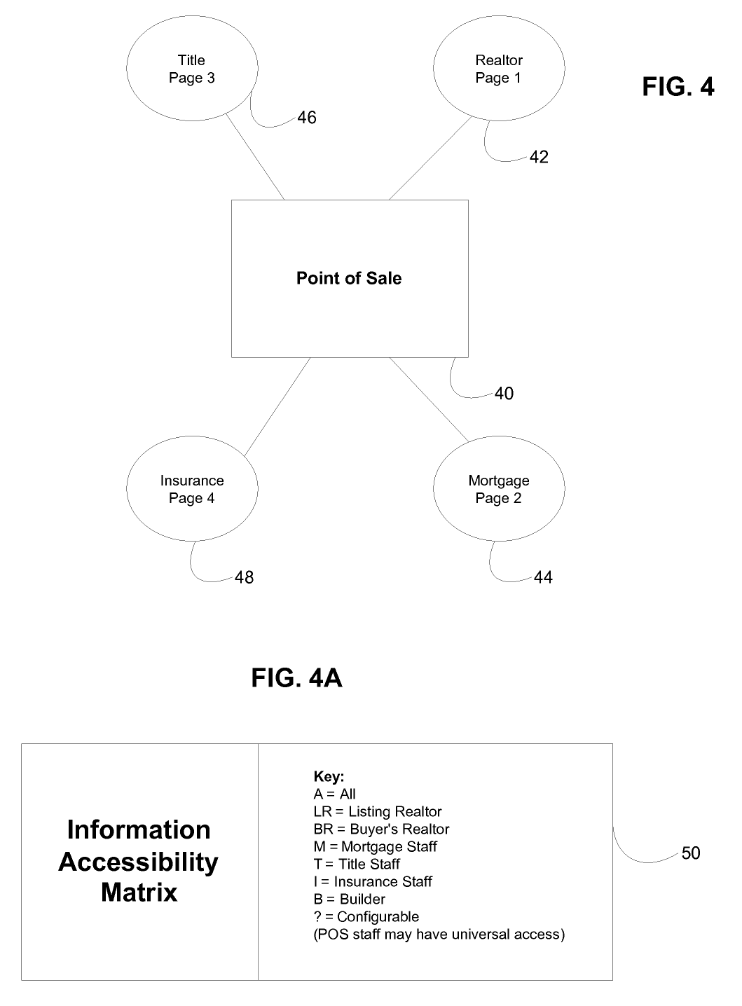

The franchisee real estate service providers offer traditional real-estate services to the consumer. To avoid a situation where provision of such services requires multiple points of data entry and inefficiencies between providers, a shared database system is provided. As shown in FIG. 3, this system, referred to herein as a Business Integration Software System or BISS 32, allows any of the real estate services providers to enter and retrieve information related to such services without having to reenter information an affiliated provider has already entered. The BISS 32 may be web based, or be usable over any type of communications network, WAN, LAN, or other proprietary network. Screens may be customized, an access can be controlled by granular access based on the service provider's identity, so that only information relevant to the service provider using the system is shown. In the event a particular service provider plays more than one role, this system may be configured to show relevant information in combination. FIG. 4 is a simplified representation of how the point of sale portal 40 allows customized web pages for the realtor 42, mortgage company 44, insurance company 48, and title company 46. BISS 32 also includes access controls, as reflected in an accessibility matrix shown as FIGS. 4A-8, which outlines firewalls the system establishes to make sure that sensitive consumer information is only viewed by those who have a legal right to view the information, and a reasonable need to view the information. BISS 32 also offers the benefits of online file storage and file management. FIG. 4A shows the key for the embodiment shown of what information is available to a particular entity based on its identity.

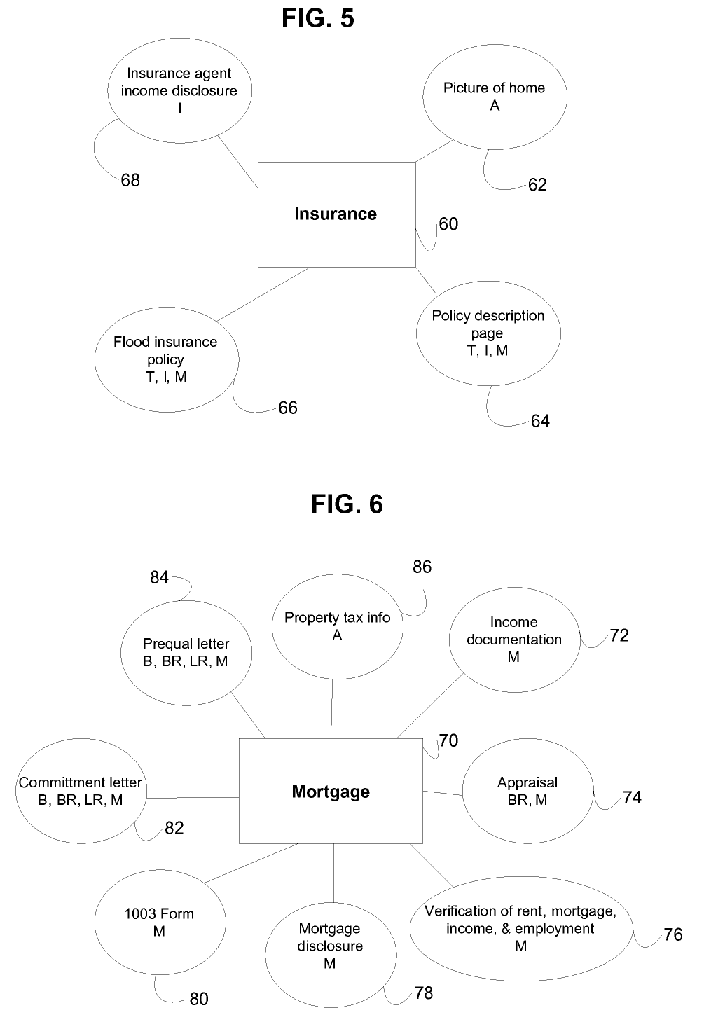

FIG. 5 shows an embodiment of web pages available via an insurance company portal 60. A picture of the home web page 62 is available to all service providers. An insurance agent income disclosure page 68 may be available only insurance company staff. A policy description page 64 may be available to title, insurance, and/or mortgage staff. A flood insurance policy page 68 may be made available to the insurance company.

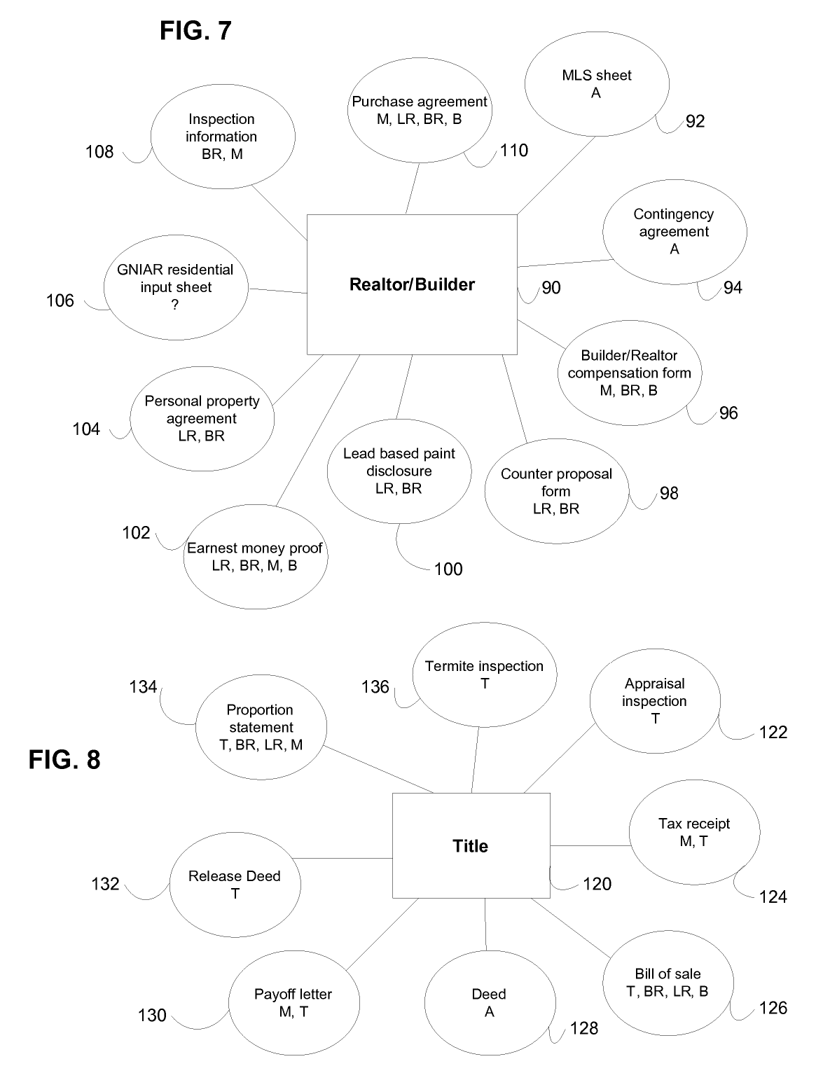

FIG. 6 shows web pages and information available from a mortgage company portal 70. Income documentation 72, appraisal 74, verification of rent, mortgage, income, and employment 76, mortgage disclosure 78, 1003 form 80, commitment letter 82, and prequal letter 84 may be made available to the mortgage company staff. Appraisal 74, the commitment letter 82, and prequal letter 84 may be made available to the buyer's realtor. The commitment letter 82 and prequal letter 84 may also be available to the builder and listing realtor. Property tax info 86 may be available to all. FIGS. 7-8 similar show availability via realtor/builder portal and title portal 120 for the following information and/or portals: MLS sheet 92, contingency agreement 94, builder/realtor compensation form 96, counter proposal form 98, lead based paint disclosure 100, earnest money proof 102, personal property agreement 104, GNIAR residential input sheet 106, inspection form 108, purchase agreement 110, appraisal inspection 122, tax receipt 124, bill of sale 126, deed 128, payoff letter 130, release deed 132, proportion statement 134, and termite inspection 136.

Additional fields and access definitions may be used including but not limited to the following. Universally viewable fields may include, but are not limited to the following. Sample drop down boxes or subdivisions of information are shown in parenthetical form. 1) Name (First, Last, and Middle Initial), 2) Current Address, 2A) Any and all past addresses where the client has lived it the last two years, 3) Home Phone, 3A) Cell Phone, 3B) Work Phone, 3C) Fax Number, 4) Last four digits of borrower Social Security Number, 5) Subject Property (Street Address, City, State, ZIP, County), 6) Property Description (Single Family Residence, Condo, Townhouse, Duplex, Triplex, and Fourplex as the six options.), 6B) Occupancy Owner-Occupied, Non-Owner Occupied (Investment Property), and Second Home. Files may be identified using any combination of client information such as, for example, the customer's Name, Address, and the last four digits of their Social Security Number.

The following information is viewable and may be entered by mortgage service providers: 1) Borrower's Current Employer, 1B) All past employers who have employed the borrower in the past two years, 1C) How long has the borrower been employed at his/her current job? Ex. X years, Y months, 1D) What is the borrower's current job title? 2) Borrowers method of tax documentation (W2, 1099, K1, and other), 3) Borrowers approximate monthly income. Ex. $ X, 4) Lender name, 5) Interest Rate- Ex. X %, 6) Amortization (Regular and Interest Only (I/O)), 7) Lien Position (1st, 2nd, and combo) 8) Loan Type (Arm, Fixed, and Balloon as the three options), 9) ARM or Balloon Type—(one or two digits in fraction form), 10) Prepayment Penalty—Ex. X Years. 10A) Is this a hard or a soft prepayment penalty?, 10B) What percentage of the loan amount must be paid to the lender if the loan is paid off before the prepayment penalty expires? Ex. X %., 11) Loan Size—Ex. $ X., 12) Loan Purpose (Cash-Out Refinance, Purchase, Rate-Term Refinance, and Other), 13) Referral Source, 14) Other Relevant Information/Notes, 15) Appraised Value—Ex. $ X, 15B) Purchase Price (if this transaction is a refinance), 16) Amount Paid for Appraisal—Ex. $ X, 17) Estimated Closing Date—Ex. XX/XX/XXXX, 18) Lender Underwriting Fee—$ X, 19) Is the borrower going to escrow for taxes and insurance—(“Will Escrow Taxes”, “Will Escrow Insurance”, “Will Escrow Both”, and “Will not Escrow”), 20) Contact information of the borrower's insurance providers—(Name, company, phone number) Ex. John Doe (555) 555-5555). An N/A box for the agent's name may be included. 21) Has the customer declared bankruptcy in the last 10 years? 21B) If so, in what month and year was it discharged? 21C) Was this a chapter 7 or chapter 13? 22) Has the customer been foreclosed on, or surrendered the deed in lieu of foreclosure in the last 10 years? 22B) If so, in what month and year did this happen? 23) Date after closing when mortgage company should contact client to review refinance options—Ex. XX/XX/XXXX. 24) What percentage equity will the customer have at closing? Ex. X %. 25) What is the borrower's Social Security Number? 26) What is the borrower's date of birth?, 27) If this is a purchase transaction, is there a down payment involved? 27A) If yes, where is the money for this down payment currently located, 28) If the transaction is a refinance, what is the borrower's current rate? Ex. X%, 28B) What is the program? 28C) Does this loan involve a prepayment penalty?

The following information about the homeowner's insurance may be entered: Homeowner's Insurance: 1) Deductible—Ex. $ X, 2) Insurance Policy Premium—Ex. $ X, 3) Nature of Policy (flood insurance, homeowner's insurance, and home warranty). 4) Underwriting Company, 5) Coverage Amount—Ex. $ X, 6) Referral Source—fillable, 7) Other Relevant Information/Notes, 8) Date Policy Takes Affect—Ex. XX/XX/XXXX, 9) Date when policy must be renewed—Ex. XX/XX/XXXX.

The following information may be entered and/or viewable related to title insurance: 1) Underwriting Company—Ex. (Name of Title Insurance Underwriter), 2) Coverage Amount—Ex. $ X, 3) Title Policy Premium—Ex. $ X, 4) Amount Paid for Title Search—Ex. $ X, 5) Date of Examination—Ex. XX/XX/XXXX, 6) Date Title Policy was ordered—Ex. XX/XX/XXXX, 7) Date when title policy should be completed—Ex. XX/XX/XXXX, 8) Date when title policy is completed—Ex. XX/XX/XXXX, 9) Other Relevant Information/ Notes.

Additional information may be collected, or the following forms/agreements may be presented that are of particular relevance to a real estate agent or builder. That information includes, but is not limited to: purchase agreement, MLS Sheet, Contingency Agreement, Builder/Real estate agent compensation form, counterproposal form, lead based disclosure, earnest money proof, personal property agreement, GNIAR residential input sheet, and an inspection form.

The mortgage provider(s) may also be provided access to the following forms/information, which includes, but is not limited to: property tax information, income documentation, appraisal, verification of rent, mortgage, income, and employment, mortgage disclosure, 1003 form, commitment letter, and prequalification letter.

A title service provider may also be provided access to the following forms/information, which includes, but is not limited to: Termite inspection, appraisal inspection, tax receipt, bill of sale, deed, payoff letter, release deed, and proportion statement.

Finally, an insurance service provider may be provided access to the following forms/information, which may include but are not limited to: insurance agent income disclosure, a picture of the home, policy description, and flood insurance.

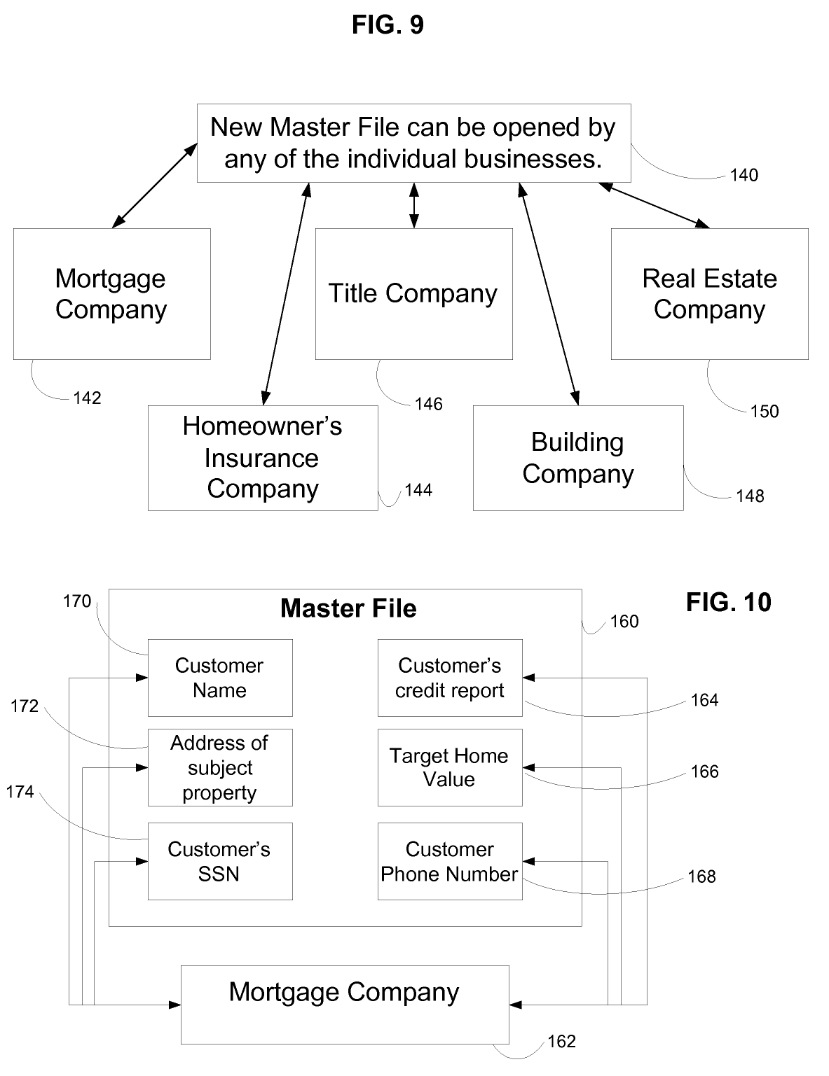

The information, forms, and agreements described above may be entered into fillable forms on the system, or alternatively, where hard copies of these materials exist, scanned and uploaded the system as an image file, such as a PDF or TIFF file. The service provider who makes use of a particular piece of information may access it directly on the system without having to maintain its own separate files. Instead, data is stored in the customer's master file. The franchisor, sub-franchisor, or a subcontractor acting on one or both of their behalf may offer this service for a fee, such as a per file fee. As shown in FIG. 9, a master file 140 can be opened by any of the service providers, including a mortgage company 142, homeowner's insurance company 144, title company 146, building company 148, or real estate company 150. These entities may be organized in the franchisor, sub-franchisor, franchisee, holding company arrangement described above.

The data is entered/accessed by appropriate service providers. The services providers may access the system over a web based interface or the like. In this manner, the affiliated service providers eliminate the costs associated with multiple rounds of data entry. The BISS 32 may be developed using a variety of known programmed and/or general purpose computers in combination with software modules operable to control the computers to provide the functionality described herein. The database features may be developed using proprietary code or using database development software such as Microsoft SQL, Oracle, Microsoft Access, and may be run on any combination of such database software and web hosting software. The software may also be configured to assist in compliance and/or audits such as by instituting one or more procedural walls between real estate service providers, tracking access by the service providers; and producing a compliance report showing the tracked access.

A simple example is shown in FIG. 10, in which a master file 160 is being updated by a mortgage company 162 to data elements customer credit report 164, target home value 166, customer phone number 168, customer name 170, address of subject property 172, and customer's social security number 174. In this example, a mortgage company meets a new client. The client wants to build a new home on a lot they own. The client also wants advice about how much house they could afford. A mortgage officer obtains the client's name, phone number, address, Social Security Number, which may be used to retrieve a credit report. The customer's credit report is uploaded into BISS. The loan officer also calculates how much of a mortgage payment the borrower could afford. The loan officer enters the data into to BISS master file.

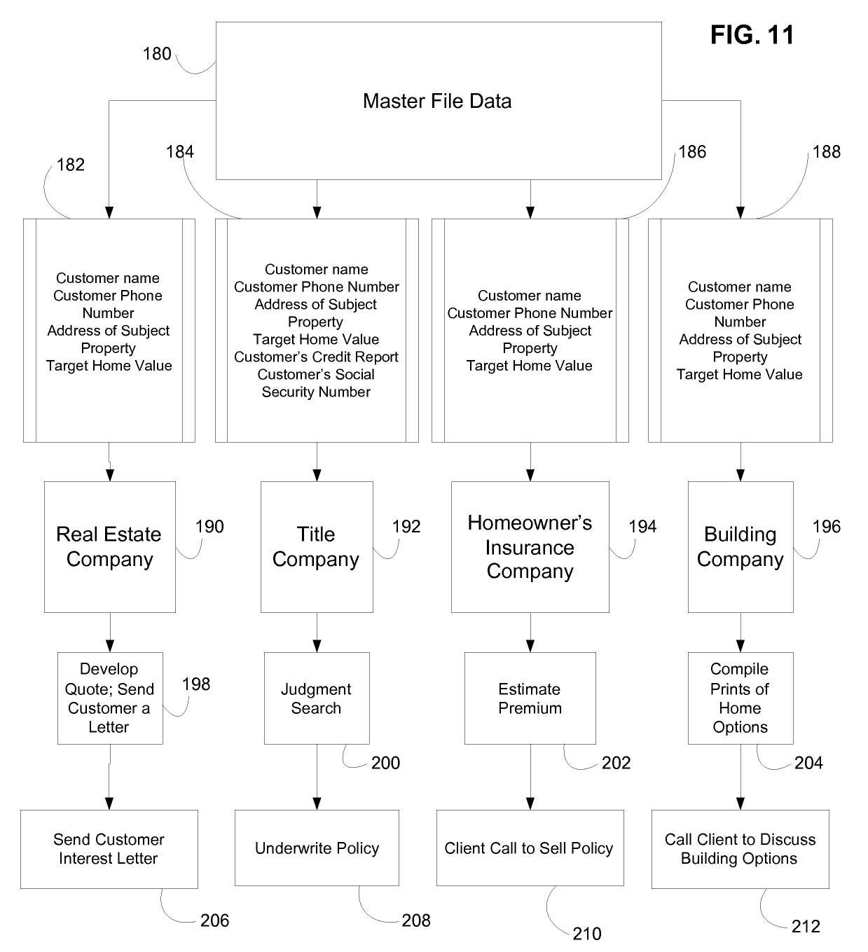

As shown in FIG. 11, a master file 180 can distill information and send this information 182, 184, 186, and 188, where beneficial and appropriate, to the related real estate services providers 190, 192, 194, 196. In turn, the real estate service providers use this information to initiate work and sales calls for these respective businesses. Real estate company 190 may use this information to develop a quote for the customer on a home warranty policy (step 198). The real estate company then sends the customer a letter and places a phone call to get the customer interested in this service (step 206). Title company 192 can use the customer's name to do a judgment search (step 200). The title company 192 can also do a title search on the subject property address and be ready to underwrite a policy that covers the amount of the target home value (step 208). A homeowner's insurance agent 194 can calculate an estimated premium since it has both the target purchase price and the customer's credit score (step 202). After calculating this policy premium, the homeowner's insurance agent can call the client to sell an insurance policy (step 210). A builder 196 could use this information to compile one or more prints of homes that fall into the price range of a client (204). The builder also has all the information necessary to get in touch with the client and set up an appointment to discuss their options in building their home (step 212).

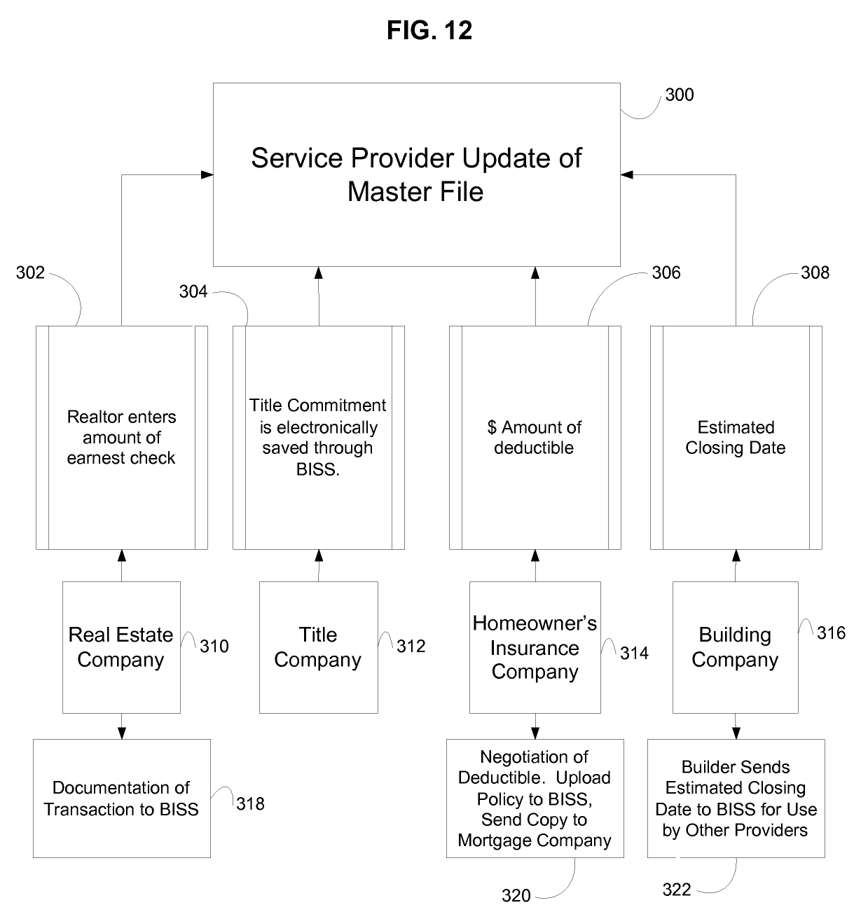

As shown in FIG. 12, a master file 300 can also receive more information on a particular customer and/or transaction as each of the individual agents contacts the client and enters information relevant to their roles into the BISS. This information may also be stored to assist in obtaining repeat business from this customer in the future. A real estate company 310 can enter an amount of an earnest check 302. A title company 312 can enter upload a title commitment document 304. A home owner's insurance company 314 can upload an amount for a deductible 306, and a building company can upload a closing date 308. In one example, a real estate company 310 will help a client borrow through the transaction at the request of the builder, who will pay this real estate sales person's cost. The real estate sales person may take an escrow check from the customer, which she documents using the BISS (step 318). The Homeowner's insurance agent 314 may talk with the client and agree on a deductible (step 320). The homeowner's insurance agent then writes the policy and electronically uploads it into the BISS. From the BISS, the mortgage company can obtain the policy, which it needs prior to underwriting the mortgage (step 320). The builder 316 determines a closing date and enters it into the BISS. Next, through the BISS, the title company, mortgage company and insurance company will be made aware of the estimated date of the closing (step 322). This is but one example of use of the BISS by different real estate service providers. Other combination of retrieving information, inputting data, and uploading sales documents may be accomplished by the present disclosure as well.

The term “computer module” or “software module” referenced in this disclosure is meant to be broadly interpreted and cover various types of software code including but not limited to routines, functions, objects, libraries, classes, members, packages, procedures, methods, or lines of code together performing similar functionality to these types of coding. The components of the present disclosure are described herein in terms of functional block components, flow charts and various processing steps. As such, it should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, SQL, C++, Java, COBOL, assembler, PERL, or the like, with the various algorithms being implemented with any combination of data structures, objects, processes, routines or other programming elements. Further, it should be noted that the present disclosure may employ any number of conventional techniques for data transmission, signaling, data processing, network control, and the like as well as those yet to be conceived.

The present BISS 32 avoids unnecessarily fragmenting service provider sales operations. Today, real estate agents, homeowner's insurance agents, and mortgage officers work independently. While some network to share and advance leads, each is only able to sell services in their respective areas of operation. Real estate owner/brokers who operate under present disclosure consolidate sales operations through the creation of real estate consulting teams. This allows real estate professionals to expend more of their time, talents, and energies toward helping clients get the right mortgage and proper insurance coverage as opposed to simply tracing each others steps chasing potential clients.

Further, many real estate professionals only receive revenue from one part of the real estate industry, and fail to take advantage of revenue from related real estate businesses (title insurance, homeowners insurance, realtor revenue, mortgage revenue, etc.). As a result, there may be four or more different firms receiving revenue from a single real estate transaction. Real estate professionals may be leaving 75% of their potential revenue streams on the table. This also forces real estate owner/brokers to spend inordinate amounts of time and human resources on sales work. The realtor, mortgage professional, title insurance company, and homeowner's insurance provider all need to invest time and money to “make the sale” on a single transaction. The BISS 32 avoids duplication by integrating services.

The present system, method, and business structure also allow professionals to operate within their core competencies. The knowledge of the mortgage industry may fall outside the core competency of the title insurance company owner. As such, new mortgage companies may have start up problems.

The present system 32 also assists smaller real estate owner brokers in maintaining appropriate training personnel. The BISS 32 may also offer internal training programs that offer both upfront training to offices that are just starting to branch into other industries, and long-term support of a central office that has the experience necessary to sustain new entrants to these fields.

The current disclosure also allows for economies of scale to allow real estate owner/brokers to profit from all industry sectors. The franchiser 10 or sub-franchisor 12 can negotiate with insurance companies and mortgage dealers to attain advantageous pricing for franchisees.

The present system also allows real estate sales agents, homeowner's insurance agents, and mortgage officers to spend more time honing the skills and learning how to help clients face the issues that stand between the client and purchasing a home, such as finding a mortgage or a homeowner's insurance policy. The present BISS 32 places the efforts of the real estate agent into a team setting, where an agent is kept current on the developments regarding financing and insurance.

The present system 32 allows individual service providers to avoid redundant overhead expenses. Receptionists, gas and electric bills, computers, maintenance, phone expenses, etc. may represent roughly 40% of current office expenses (excluding compensation). These costs are eventually passed down to customers of mortgage companies, real estate agents, and title companies. With the current system, these services may be offered from an integrated provider with the saving being passed down to the end clients.

The present system allows those who do not focus on finding clients or marketing to concentrate on providing services within their area of expertise. The BISS 32 creates a structure where mortgages programs are chosen, personalized, and written by service providers who spend their time tailoring mortgage programs, not by salespeople whose pay structure places a premium on the quantity of their clients as opposed to the quality with which they are served.

The present system also provides a purchaser with more choice. Today, many potential homebuyers are referred to large national banks, whose loan personnel do not enjoy the range of flexible loan programs that mortgage brokers enjoy. The present BISS 32 services clients through a broker wholesale operation as opposed to a local bank. Brokers have several major advantages over banks. Brokers have access to more programs. For example, a mortgage broker has access to programs offered by many mortgage wholesalers. Loan officers at large banks and the mortgage institutions run by national real estate chains can usually only offer a handful of programs directly funded by their institution.

This difference has tangible consequences for end consumers. Many bank loan officers only offer programs for “A” paper borrowers. This standard offers no programs for self-employed individuals, people who have not worked in their professions for at least two years, buyers interested in “fixer-upper” homes, persons going through a divorce, individuals who have filed bankruptcies, persons whose income is not easily verified, persons seeking 100% financing, etc. These loans involve significant risk factors that make these loans unsuitable for low-risk investment portfolios. Many loan officers who work for traditional banks will tell individuals facing these obstacles that a mortgage is unavailable despite the fact that there are plenty of reputable lenders who not only want, but seek out customers looking for specialty loan products.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicants have provided description and figures which are intended as illustrations of embodiments of the disclosure, and are not intended to be construed as containing or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation.

What is claimed is:

1. A method for providing integrated real estate related services, the method comprising the steps of:
establishing an affiliation among a franchisor and at least one sub-franchisor,
establishing at least one franchisee for each sub-franchisor, the franchisee being formed as a holding company to hold one or more real estate service providers; and
having the one or more real estate service providers provide real estate services to consumers.

2. The method of claim 1, further comprising the franchisee compensating the sub-franchisor in connection with providing the real estate services.

3. The method of claim 2, wherein the compensation is a franchise fee.

4. The method of claim 3, wherein the franchise fee is based on a percentage of a margin collected on a provided real estate service.

5. The method of claim 4, further comprising the sub-franchisor paying at least a portion of the franchise fee to the franchisor.

6. The method of claim 4, further comprising one of the franchisor and the sub-franchisor providing assistance services to the franchisee.

7. The method of claim 6, the assistance services comprising one or more of helping setting up the holding company, business development, training, help with regional laws, help with regional regulations, local technology support, and advertising services.

8. The method of claim 7, wherein the real estate service providers are one or more of: a real estate broker-owner, a title company, an insurance broker, a mortgage broker, and a builder.

9. The method of claim 8, further comprising at least a portion of the assistance services being providing on a shared database system for use by the real estate service providers.

10. The method of claim 9, allowing the real estate service providers to have one or more of add, modify, and delete rights for data, the rights being granularly controlled based on a type of the real estate service provider.

11. The method of claim 10, wherein at least a portion of the customer data is universally viewable by the service providers.

12. The method of claim 11, wherein at least a portion of the customer data is viewable and may be added by a mortgage service provider.

13. The method of claim 11, wherein at least a portion of the customer data is viewable and may be added by a homeowners insurance service provider.

14. The method of claim 11, wherein at least a portion of the customer data is viewable and may be added by a title insurance service provider.

15. The method of claim 11, wherein a service provider is allowed access to one or more of a form and data entered into the form, based on the identity of the service provider.

16. The method of claim 15, further comprising providing the forms online as one or both of a fillable form and a fillable Personal Document Format (PDF) file.

17. The method of claim 16, further comprising a customer-facing interface for entering information into the form.

18. The method of claim 10, further comprising:
instituting one or more procedural walls between real estate service providers;
tracking access by the service providers; and
producing a compliance report showing the tracked access.

19. A system for providing integrated real estate services comprising a general purpose computer operated by a software module operative to:
provide a point of sale interface available over a communications network to at least one consumer;
displaying at least one form related to sales of real estate on the point of sale interface;
allowing a consumer to input information into the at least one form;
populating a master file for the consumer based on the information; and
providing access to the selected information in the master file to at least one real estate service provider via the communications network.

20. The system of claim 19, further comprising the software module being operate to allow the at least one real estate service provider to input service information into the master file based on information from one or more of information from the consumer and information entered by at least one other real estate service provider.
